(19) United States
(12) Patent Application Publication
(10) Pub. No.: US 2024/0054420 A1
(43) Pub. Date: Feb. 15, 2024

(54) CAUSAL ACTIVITY IDENTIFYING APPARATUS, CAUSAL ACTIVITY IDENTIFYING METHOD AND PROGRAM

(71) Applicant: NIPPON TELEGRAPH AND TELEPHONE CORPORATION, Tokyo (JP)

(72) Inventor: Shinobu SAITO, Tokyo (JP)

(73) Assignee: NIPPON TELEGRAPH AND TELEPHONE CORPORATION, Tokyo (JP)

(21) Appl. No.: 18/280,169

(22) PCT Filed: Mar. 5, 2021
(86) PCT No.: PCT/JP2021/008732

§ 371 Date: Sep. 1, 2023

(51) Int. Cl. G06Q 10/0633

(52) U.S. Cl. CPC G06Q 10/0633

(57) ABSTRACT

A causal process specification device includes a detection unit that extracts a pattern of a business process from log data indicating an execution history of a process that constitutes a business process, and detects a loop of the process for each of the pattern, a specification unit that specifies, in the order of the process in the pattern in which the loop is detected, a process included in a predetermined range going back from the start of the loop, and an output unit that outputs information indicating a process specified by the specification unit so as to support specification of a process causing a problem in a business process.

### TECHNICAL FIELD

The present invention relates to a causal process specification device, a causal process specification method, and a program.

### BACKGROUND ART

A technique for visualizing patterns of business processes on the basis of data (logs) accumulated in a system has been proposed (Patent Literature 1). On the other hand, as services required for a system become larger and more complex, the number of patterns of the execution order of business processes becomes enormous. Therefore, it is necessary to efficiently find a pattern including a process (=activity) in which a problem such as stagnation (loop) occurs.

### CITATION LIST

### Patent Literature

Patent Literature 1: JP 2017-187953 A

### SUMMARY OF INVENTION

### Technical Problem

The loop is often caused by a preceding process of a process where a problem occurs, and it is necessary to investigate not only the process where the problem occurs but also the preceding process (the process causing the problem) in order to solve the problem.

The technique disclosed in Patent Literature 1 can contribute to specifying a problem (loop) generation process (Activity). However, in a case where there is a plurality of inflows into the process where the problem occurs (transition between the processes), it is difficult to determine the preceding process of the process where the problem occurs by graph representation or matrix representation which is a general process visualization method.

FIG. 1 is a diagram for describing a problem of a conventional technique. In FIG. 1, (1) illustrates an example in which a certain business process is visualized by graph representation, and (2) illustrates an example in which the same business processes are visualized by an adjacent matrix. In the drawings, symbols A to D indicate separate processes.

According to (1) and (2), it can be understood that the process B loops 10 times. However, it is difficult to determine whether the loop of 10 times has occurred after the process A or after the process C (that is, whether the loop of 10 times is caused by A or C).

The present invention has been made in view of the above points and is directed to supporting specification of a process causing a problem in a business process.

### Solution to Problem

Therefore, in order to solve the above problem, a causal process specification device includes a detection unit that extracts a pattern of a business process from log data indicating an execution history of a process that constitutes a business process, and detects a loop of the process for each of the pattern, a specification unit that specifies, in the order of the process in the pattern in which the loop is detected, a process included in a predetermined range going back from the start of the loop, and an output unit that outputs information indicating a process specified by the specification unit.

### Advantageous Effects of Invention

It is possible to support specification of a process that causes a problem in a business process.

### BRIEF DESCRIPTION OF DRAWINGS

FIG. 1 is a diagram for describing a problem of a conventional technique.

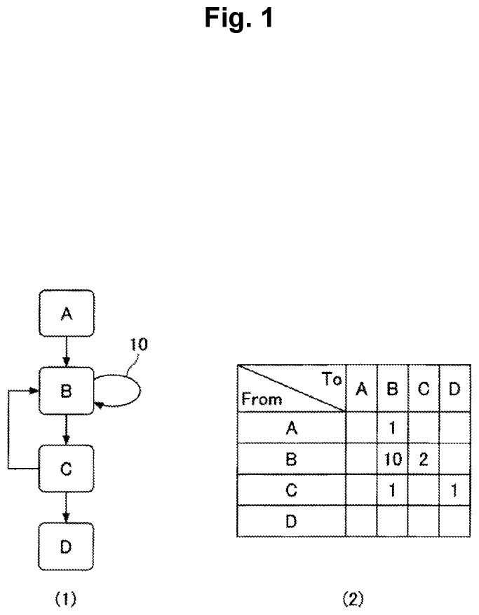

FIG. 2 is a diagram illustrating a hardware configuration example of a causal process specification device 10 according to an embodiment of the present invention.

FIG. 3 is a diagram illustrating a functional configuration example of the causal process specification device 10 according to an embodiment of the present invention.

FIG. 4 is a flowchart for describing an example of a processing procedure performed by the causal process specification device 10.

FIG. 5 is a diagram illustrating a configuration example of a log storage unit 15.

FIG. 6 is a diagram illustrating a configuration example of a PAL table.

FIG. 7 is a diagram illustrating a configuration example of an L1 loop table.

FIG. 8 is a diagram illustrating a configuration example of an L2 loop table.

### DESCRIPTION OF EMBODIMENTS

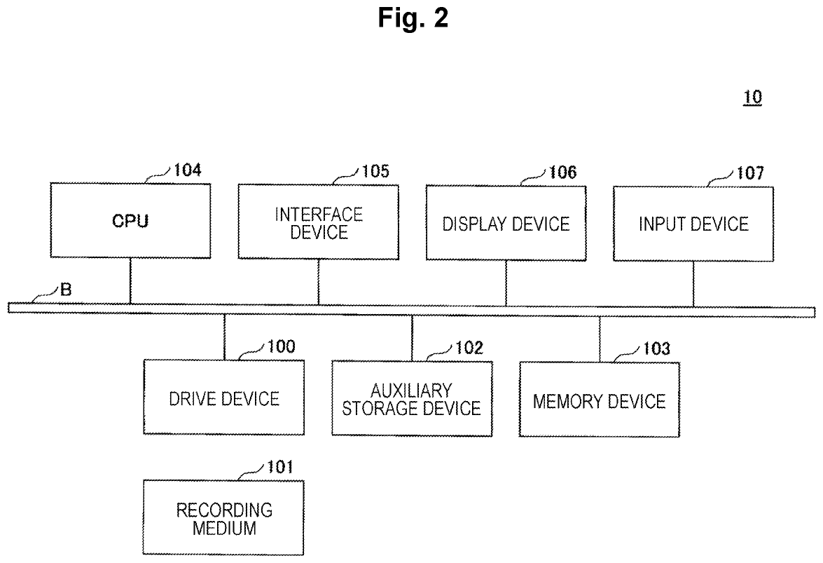

Hereinafter, embodiments of the present invention will be described with reference to the drawings. FIG. 2 is a diagram illustrating a hardware configuration example of a causal process specification device 10 according to an embodiment of the present invention. The causal process specification device 10 in FIG. 2 includes a drive device 100, an auxiliary storage device 102, a memory device 103, a CPU 104, an interface device 105, a display device 106, an input device 107, and the like, which are connected to one another via a bus B.

A program for implementing processing in the causal process specification device 10 is provided by a recording medium 101 such as a CD-ROM. If the recording medium 101 storing the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores necessary files, data, and the like.

In a case where an instruction to start the program is issued, the memory device 103 reads the program from the auxiliary storage device 102 and stores the program. The CPU 104 implements a function related to the causal process specification device 10 in accordance with a program stored in the memory device 103. The interface device 105 is used as an interface for connecting to a network. The display device 106 displays a graphical user interface (GUI) or the like by the program. The input device 107 includes a keyboard, a mouse, and the like, and is used to input various operation instructions.

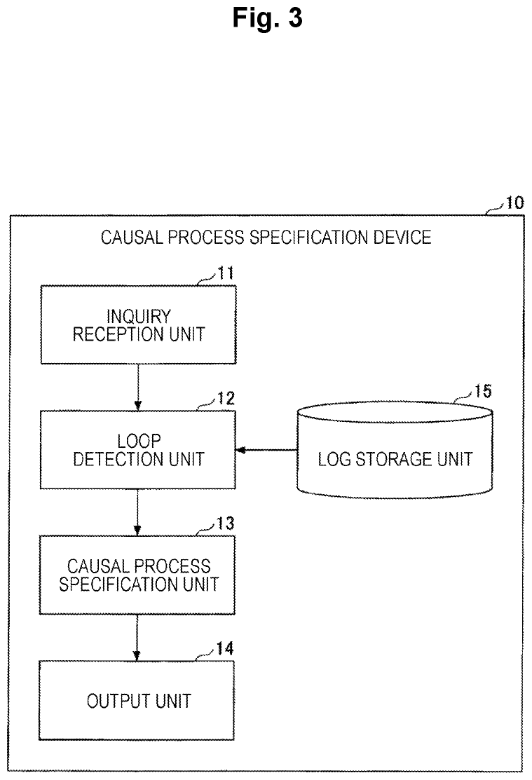

FIG. 3 is a diagram illustrating a functional configuration example of the causal process specification device 10 according to an embodiment of the present invention. In FIG. 3, the causal process specification device 10 includes an inquiry reception unit 11, a loop detection unit 12, a causal process specification unit 13, an output unit 14, and the like. Each of these units is implemented by processing performed by the CPU 104 by one or more programs installed in the causal process specification device 10. The causal process specification device 10 also uses a log storage unit 15. The log storage unit 15 can be implemented by using, for example, the auxiliary storage device 102 or a storage device connectable to the causal process specification device 10 via a network.

The log storage unit 15 stores log data indicating an execution history of processes that constitutes a business process.

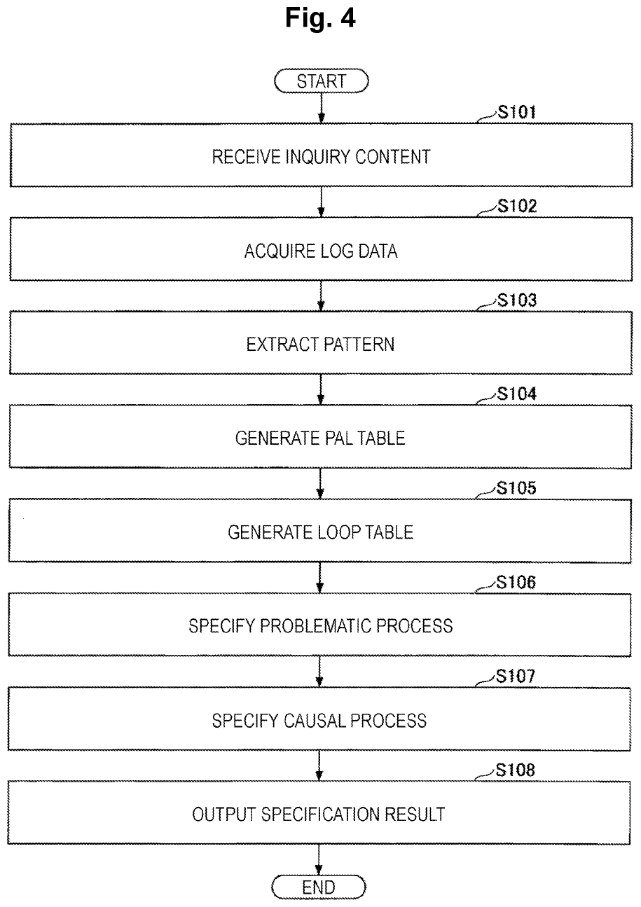

Hereinafter, a processing procedure performed by the causal process specification device 10 will be described. FIG. 4 is a flowchart for describing an example of a processing procedure performed by the causal process specification device 10.

In step S101, the inquiry reception unit 11 receives an inquiry content from the user. The inquiry content is information (parameter) including a condition for specifying (or searching for) a process in which a problem (loop) occurs in a business process (hereinafter, referred to as a “problematic process”), a condition for specifying (or searching for) a preceding process that is highly likely to be a cause of the problem (hereinafter, simply referred to as “causal process”), and the like. In the present embodiment, the inquiry content includes the length of the loop, the number of occurrences, the number of previous processes, and the like.

The length of the loop and the number of occurrences are parameters that constitutes conditions for specifying the problematic process. The length of the loop refers to the number of processes that constitute the loop (stagnation) in the business process. For example, when a loop is occurred in one process (when one process is repeated twice or more), the length of the loop is one. On the other hand, when a loop is occurred across the two processes (when two processes in turn are repeated twice or more), the length of the loop is two. The number of occurrences is the number of times of a loop.

The number of previous processes is a parameter that constitutes conditions for specifying the causal process. The number of previous processes is designated by a numerical value indicating how many processes up to a range traced back from the problematic process are to be the cause identification.

Subsequently, the loop detection unit 12 acquires the log data stored in the log storage unit 15 (S102).

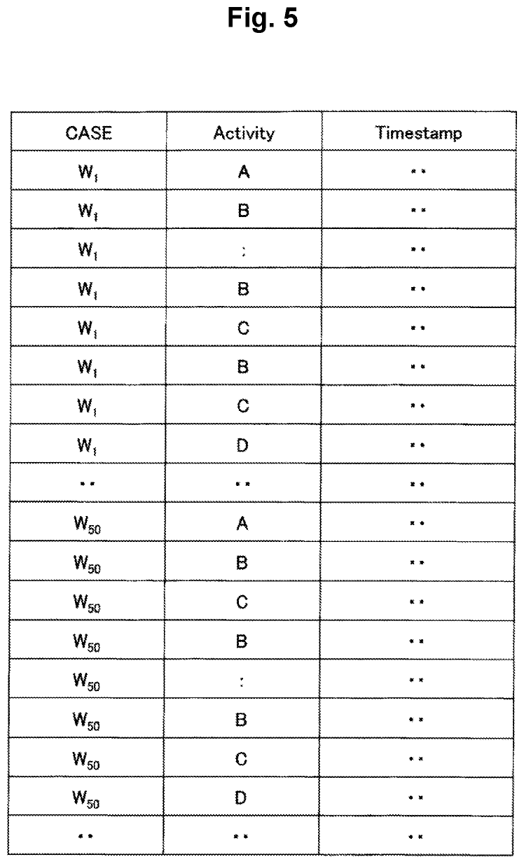

FIG. 5 is a diagram illustrating a configuration example of the log storage unit 15. As illustrated in FIG. 5, the log storage unit 15 stores logs related to business processes in chronological order. Each log includes values of items such as “Case”, “Activity”, and “Timestamp”.

The “Case” is unique identification information for each actually executed business process. The “Activity” is identification information of a process executed in a business process related to the “Case”. “Timestamp” is the date and time when the process was executed.

Such log data may be recorded, for example, in a computer system used for execution of business. For example, each operation on the computer system may be associated with one Activity (process).

Subsequently, the loop detection unit 12 extracts a business process pattern (hereinafter, simply referred to as a “pattern”) from the log data (S103). The pattern refers to a type of execution order of processes in a business process. Therefore, the loop detection unit 12 extracts, for each business process group having a common execution order of processes in the log data, the execution order of the processes as a pattern, and assigns identification information to each pattern (hereinafter, referred to as a “pattern ID”). Additionally, when extracting the pattern, the loop detection unit 12 may count the number of appearances of each pattern (that is, the number of business processes classified into each pattern) and associate the count result with each pattern.

Subsequently, the loop detection unit 12 generates a table (hereinafter, referred to as a “PAL table”; PAL stands for pattern and ordered-activity list) indicating the relationship between the pattern and the execution order of the processes (indicating the execution order of the processes in each pattern) based on the extraction result of the pattern (S104).

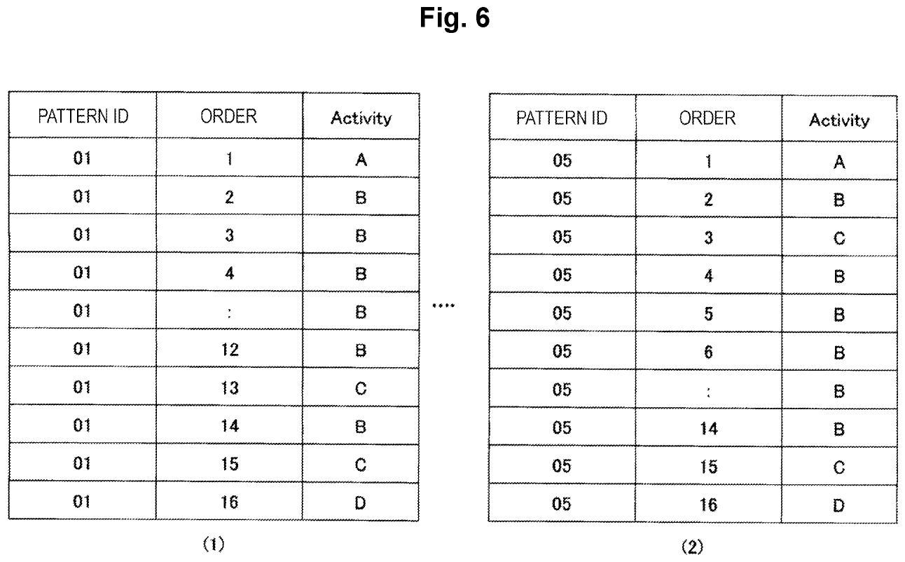

FIG. 6 is a diagram illustrating a configuration example of the PAL table. As illustrated in FIG. 6, the PAL table has items such as “Pattern ID”, “Order”, and “Activity”, and each row of the PAL table includes the values of these items for each process (Activity) that constitutes the pattern.

The “Pattern ID” is a pattern ID of the pattern extracted in step S103. A row group having a common pattern ID corresponds to one pattern. The “Activity” is identification information of a process that constitutes a pattern. The “Order” is a numerical value indicating the execution order of the process in the pattern. Even when the same process is repeated (that is, in a case where a loop occurs), a unique order is assigned to each process. For example, (1) of FIG. 6 illustrates the PAL table of the pattern with the pattern ID is “01” (hereinafter, referred to as a “pattern 01”), but illustrates an example in which the process B (Activity=B) is repeated 10 times. The order of 2 to 12 is assigned to each of the 10 B processes in ascending order. Similarly, (2) of FIG. 6 illustrates the PAL table of the pattern with the pattern ID is “05” (hereinafter, referred to as a “pattern 05”), but illustrates an example in which the process B (Activity=B) is repeated 10 times. The order of 4 to 14 is assigned to each of the 10 B processes in ascending order.

Note that, in FIG. 6, for convenience, a separate table is used for each pattern, but one PAL table may be generated for a plurality of patterns.

Subsequently, the loop detection unit 12 detects a loop in each pattern based on the PAL table and generates a loop table (S105). At this time, the loop detection unit 12 changes the loop to be detected and the loop table to be generated according to length N of the loop of the inquiry content. Specifically, in the case of N=1, the loop detection unit 12 detects (searches for) only a loop having the length of one in the order of “Order” in the PAL table, and generates a loop table for the loop having the length of one (hereinafter, referred to as the “L1 (Length-1) loop table”). Therefore, in this case, a loop having length of two or more is ignored.

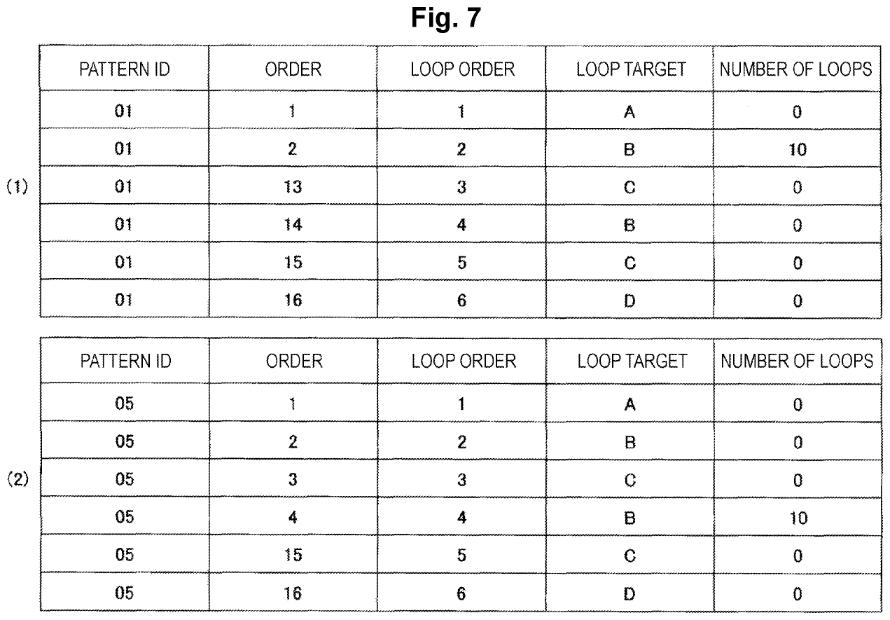

FIG. 7 is a diagram illustrating a configuration example of the L1 loop table. In FIG. 7, (1) illustrates an L1 loop table for the pattern 01, and (2) illustrates an L1 loop table for the pattern 05. However, similarly to the PAL table, one loop table may be generated for a plurality of patterns instead of each pattern.

As illustrated in FIG. 7, an L1 routing table has items such as “Pattern ID”, “Order”, “Loop order”, “Loop target”, and “Number of loops”, and each row of the L1 routing table includes these values for every zero or more loops of one process. In the present embodiment, when the same process is not continuous (in a case where the same process is continuous once), the number of loops of the process is zero. In a case where the same process continues twice, the number of loops of the process is once. That is, in a case where the same process continues M times, the number of loops of the process is M-1. Therefore, the loop detection unit 12 detects a plurality of rows in which one process continues twice or more in the PAL table as a loop, and integrates (aggregates) these rows into one row in the L1 loop table.

The “Order” is the order in the pattern (PAL table) for the first process in the loop according to each row (first order in the loop).

The “Loop order” is the order (turn) of each row in the L1 loop table. That is, the “Loop order” is an order (turn) in units of loops.

The “Loop target” is identification information (Activity) of a process that is a target of zero or more loops (loop range). The loop target in the case of N=1 is one process.

The “Number of loops” is the number of loops corresponding to each row. As described above, in a case where the number of consecutive times of the same process is M, the number of loops is M-1.

According to FIG. 7, in the pattern 01, the number of loops of the process B with the loop order of 2 is 10, and in the pattern 05, the number of loops of the process B with the loop order of 4 is 10.

On the other hand, in the case of N=2, the loop detection unit 12 detects (searches for) only a loop having the length of two in the order of “Order” in the PAL table, and generates a loop table for the loop with the length of two (hereinafter, referred to as the “L2 (Length-2) loop table”).

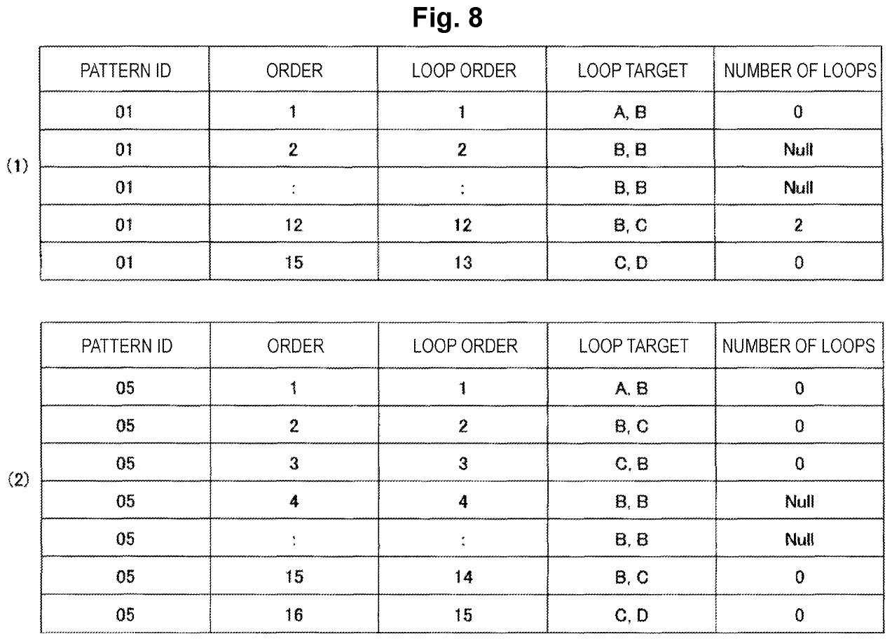

FIG. 8 is a diagram illustrating a configuration example of the L2 loop table. As illustrated in FIG. 8, the items of the L2 loop table are the same as those of the L1 loop table. However, the expressions of the values of the “Loop target” and the “Number of loops” are different.

In the L2 loop table, since two processes adjacent in the order correspond to one row, two consecutive processes in the PAL table are recorded in the “Loop target”. In addition, in the PAL table, when the same “Loop target” row group is continuous twice or more, these row groups continuous twice or more are integrated (aggregated) into one row in the L2 table.

In addition, “Null” may be recorded in the “Number of loops” of the L2 loop table. The “Null” is recorded for successive rows of one process (that is, a loop of length one). This is because, in the L2 loop table, a loop of length one is not counted.

Subsequently, the causal process specification unit 13 specifies the problematic process based on the loop table (S106). Specifically, the causal process specification unit 13 specifies, as a problematic process, the “Loop target” in a row in which the “Number of loops” matches the number of occurrences of the inquiry content in the loop table.

For example, when the loop length of the inquiry content is one and the number of occurrences of the inquiry content is 10 times or more (hereinafter, referred to as a “case 1”), the causal process specification unit 13 specifies, as problematic processes, a process B in which the loop order of the pattern 01 is 2 and a process B in which the loop order of the pattern 05 is 4 in the L1 loop table (FIG. 7).

Alternatively, when the loop length of the inquiry content is two and the number of occurrences of the inquiry content is twice or more (hereinafter, referred to as a “case 2”), the causal process specification unit 13 specifies, as problematic processes, a process “B, C” in which the loop order of the pattern 01 is 12 in the L2 loop table (FIG. 8).

Subsequently, the causal process specification unit 13 specifies the causal process based on the specification result of the problematic process and the number of previous processes of the inquiry content (S107). Specifically, the causal process specification unit 13 specifies, as a causal process, a preceding process in which the value of the “order” in the PAL table (FIG. 6) is included in a range traced back by the number of previous processes from the value of the “order” of the problematic process in the loop table (that is, the order of the processes of starting the loop).

For example, in the case 1, the “order” in the L1 loop table of the process B that is a problematic process for the pattern 01 is 2, and the “order” in the L1 loop table of the process B that is a problematic process for the pattern 05 is 4. Therefore, when the number of previous processes of the inquiry content is one, the causal process specification unit 13 specifies the process A having a value of 2-1=1 as the “order” in the PAL table as the causal process for the pattern 01. Further, the causal process specification unit 13 specifies the process C having a value of 4-1=3 as the “order” in the PAL table as the causal process for the pattern 05.

On the other hand, in the case 2, the value of the “order” in the L2 loop table of the process “B, C” which is a problematic process for the pattern 01 is 12. In this case, when the number of previous processes of the inquiry content is two, the causal process specification unit 13 specifies processes (10th B and 11th B) included in a range going back to a process having a value of “order” of 12-2=10 in the PAL table as causal processes. Additionally, when the number of previous processes of the inquiry content is three, the causal process specification unit 13 specifies processes (9th B, 10th B, and 11th B) included in a range going back to a process having a value of “order” of 12-3=9 in the PAL table as causal processes. Further, when the number of previous processes of the inquiry content is three, the causal process specification unit 13 specifies a process (11th B) included in a range going back to a process having a value of “order” of 12-1=11 in the PAL table as causal processes.

Subsequently, the output unit 14 outputs the information indicating the pattern ID and the causal process for each problematic process (S108).

For example, in the case of Case 1, the following contents are output:
problematic process: B (Pattern 01, causal process: A); and
problematic process: B (Pattern 05, causal process: C).

Further, in the case of Case 2, the following content is output:
problematic processes: B and C (Pattern: 01, causal processes: B and B).

Note that the output unit may output the number of appearances of each pattern, or may sort the output order of the problematic process or the like in descending order of the number of appearances of the pattern. That is, it is considered that the causal process of the pattern having a large number of appearances is more important, therefore it is possible to notify the user of the causal process having a high priority by performing such output.

In the above description, the case of N=1 or 2 has been described, but even in the case of N=3 or more, the causal process can be specified by the same principle.

As described above, according to the present embodiment, it is possible to support specification of a process that causes a problem in a business process.

In addition, although there is a possibility that a cause and a solution of the problem also change depending on the length of the loop, according to the present embodiment, it is possible to specify a causal process according to the length of the loop.

Note that, in the present embodiment, the loop detection unit 12 is an example of a detection unit. The causal process specification unit 13 is an example of a specification unit.

Although the embodiments of the present invention have been described in detail above, the present invention is not limited to such specific embodiments, and various modifications and changes can be made within the scope of the gist of the present invention described in the claims.

### REFERENCE SIGNS LIST

10 Causal process specification device
11 Inquiry reception unit
12 Loop detection unit
13 Causal process specification unit
14 Output unit
15 Log storage unit
100 Drive device
101 Recording medium
102 Auxiliary storage device
103 Memory device
104 CPU
105 Interface device
106 Display device
107 Input device
B Bus

1. A causal process specification device comprising a processor configured to execute operations comprising:
extracting a pattern of a task from log data the pattern indicates a type of a sequence of processes of the task, and the log data indicates an execution history of performing a process of the processes, and the process represents a part of the task;
detecting a loop of the process according to the pattern;
specifying, according to the sequence of the processes in the pattern in which the loop is detected, a previous process included in a predetermined range preceding a start of the loop; and
outputting information indicating the specified process.

2. The causal process specification device according to claim 1, wherein the detecting further comprises detecting the loop that repeats a predetermined number of times or more.

3. The causal process specification device according to claim 1, wherein the detecting further comprises detecting the loop constituted by a predetermined number of processes.

4. A method for specifying a causal process, comprising:
extracting a pattern of a task from log data, the pattern indicates a type of a sequence of processes of the task, and the log data indicates an execution history of performing a process of the processes, and the process represents a part of the task;
detecting a loop of the process according the pattern;
specifying, according to the sequence of the processes in the pattern in which the loop is detected, a previous process included in a predetermined range preceding a start of the loop; and
outputting information indicating the specified process.

5. The causal process specification method according to claim 4, wherein the detecting further comprises detecting the loop that repeats a predetermined number of times or more.

6. The causal process specification method according to claim 4, wherein the detecting further comprises detecting the loop constituted by a predetermined number of processes.

7. A computer-readable non-transitory recording medium storing computer-executable program instructions that when executed by a processor causes a computer system to execute operations comprising:
extracting a pattern of a task from log data, the pattern indicates a type of a sequence of processes of the task, and the log data indicates an execution history of performing a process of the processes, and the process represents a part of the task;
detecting a loop of the process according to the pattern;
specifying, according to the sequence of the processes in the pattern in which the loop is detected, a previous process included in a predetermined range preceding a start of the loop; and
outputting information indicating the specified process.

8. The causal process specification device according to claim 1, wherein the log data includes:
a first identifier of the task,
a second identifier of the process in the task,
a timestamp indicating a time when the process was performed.

9. The causal process specification device according to claim 1, wherein the loop indicates a repeat of performing the process.

10. The causal process specification device according to claim 1, the processor further configured to execute operations comprising:
generating a first table, wherein the table includes:
a first identifier of the pattern,
a second identifier of the process in the task, and
a numerical value indicating the sequence of processes of the task, the detecting the loop uses the first table; and
generating a second table, wherein the second table includes:
the first identifier of the pattern as the loop,
a numerical value indicating the sequence of processes of the task,
a sequence of the loop among loops, and
a number of times of repeating the loop, and the specifying the previous process uses the second table to specify the previous process as a causal process of a problem.

11. The causal process specification device according to claim 1, the processor further configured to execute operations comprising:
interactively receiving an inquiry, wherein the inquiry includes:
first search parameter data for identifying the process of the task associated with a problem,
second search parameter data for identifying the previous process anticipated as a causal process of the problem,
a length of the loop,
a number of occurrences of the loop, and
the number of predetermined range proceeding the start of the loop.

12. The method according to claim 4, wherein the log data includes:
a first identifier of the task,
a second identifier of the process in the task,
a timestamp indicating a time when the process was performed.

13. The method according to claim 4, wherein the loop indicates a repeat of performing the process.

14. The method according to claim 4, further comprising:
generating a first table, wherein the table includes:
a first identifier of the pattern,
a second identifier of the process in the task, and
a numerical value indicating the sequence of processes of the task, the detecting the loop uses the first table; and
generating a second table, wherein the second table includes:
the first identifier of the pattern as the loop,
a numerical value indicating the sequence of processes of the task,
a sequence of the loop among loops, and
a number of times of repeating the loop, and the specifying the previous process uses the second table to specify the previous process as a causal process of a problem.

15. The method according to claim 4, further comprising:
interactively receiving an inquiry, wherein the inquiry includes:
first search parameter data for identifying the process of the task associated with a problem,
second search parameter data for identifying the previous process anticipated as a causal process of the problem,
a length of the loop,
a number of occurrences of the loop, and
the number of predetermined range proceeding the start of the loop.

16. The computer-readable non-transitory recording medium according to claim 7, wherein the detecting further comprises detecting the loop that repeats a predetermined number of times or more.

17. The computer-readable non-transitory recording medium according to claim 7, wherein the detecting further comprises detecting the loop constituted by a predetermined number of processes.

18. The computer-readable non-transitory recording medium according to claim 7, wherein the log data includes:
a first identifier of the task,
a second identifier of the process in the task,
a timestamp indicating a time when the process was performed.

19. The computer-readable non-transitory recording medium according to claim 7, wherein the loop indicates a repeat of performing the process.

20. The computer-readable non-transitory recording medium according to claim 7, the computer-executable program instructions when executed further causing the computer system to execute operations comprising:
interactively receiving an inquiry, wherein the inquiry includes:
first search parameter data for identifying the process of the task associated with a problem,
second search parameter data for identifying the previous process anticipated as a causal process of the problem,
a length of the loop,
a number of occurrences of the loop, and
the predetermined range preceding the start of the loop;
generating a first table, wherein the table includes:
a first identifier of the pattern,
a second identifier of the process in the task, and
a numerical value indicating the sequence of processes of the task, the detecting the loop uses the first table; and
generating a second table, wherein the second table includes:
the first identifier of the pattern as the loop,
a numerical value indicating the sequence of processes of the task,
a sequence of the loop among loops, and
a number of times of repeating the loop, and
the specifying the previous process uses the second table to specify the previous process as a causal process of a problem.
